(19) United States
(12) Patent Application Publication
(10) Pub. No.: US 2013/0032245 A1
(43) Pub. Date: Feb. 7, 2013

(54) Laundry Detergent Container and Method for Making a Laundry Detergent Container

(71) Applicant: Emily Frazer, Buffalo, NY (US)

(72) Inventor: Emily Frazer, Buffalo, NY (US)

(21) Appl. No.: 13/385,589

(22) Filed: Jun. 2, 2011

(51) Int. Cl. B65B 3/06; B65D 5/74; B67D 7/22

(52) U.S. Cl. 141/95; 141/311 R; 53/467

(57) ABSTRACT

A containment and delivery device for liquid laundry detergent is provided. A dispensing nozzle is attached to a flexible bladder filled with a laundry detergent. The bladder is placed within an enclosure. The enclosure includes a perforated portion which is used to form an aperture for accessing the dispensing nozzle to dispense the laundry detergent. The enclosure is structurally strong enough to allow for the stacking of multiple containers.

### FIELD OF THE INVENTION

This invention pertains to fluid containers, and more particularly, to liquid laundry detergent containers.

### BACKGROUND OF THE INVENTION

In the household consumables industry, container design and functionality is important to perceived value. Consumers desire containers that provide high volumes of product, yet remain easy to carry and use. Consumers also put a premium on products that are environmentally friendly—through the use of biodegradable materials or by reducing the amount of material needed to create the container. Additionally, the household consumables industry is extremely competitive. Manufacturers need container solutions that are less expensive to produce and more efficient to transport to the point of sale.

Designing a container to transport and dispense fluids is additionally difficult. Without some rigidity, the container becomes amorphous, difficult to carry, and prone to rupture. Although portable fluid containers are generally well adapted to consumer use, there are several known disadvantages.

A particular problem with fluid containers is that they are not easily adaptable to the requirements of the particular contents, or the needs of the distribution channel in which they are sold. This is especially apparent for fluids with high viscosity. Some current designs require the user to lift and pour the contents of the container. These designs generally require a narrow spout at the top of the container. The narrow spout makes stacking the containers difficult and susceptible to damage in transit.

Another problem inherent with fluid containers is their increased production costs. Generally, fluid containers are made from a polymer such as high-density polyethylene or some other material that is rigid and fluid-tight. Sufficient material is required so that the container can maintain its shape. Also, materials such as high-density polyethylene (“HDPE”) are typically injection molded, blow-molded, or roto-molded and as such, the shape of the final container is limited by shapes that can be easily molded at production volumes.

### SUMMARY OF THE INVENTION

The present invention aims to overcome these problems through a combination of features that allow for the containment and delivery of laundry detergent through a container that requires less expensive materials to fabricate and allows for more efficient transportation.

A flexible bladder is filled with a viscous liquid. A dispensing nozzle is attached to the bladder in such a manner that creates an air-tight seal. The bladder is placed within a substantially cubic enclosure. The enclosure can be secured and may include a handle that allows a user to better grip the container. The enclosure may be made of a low-cost material such as corrugated cardboard. The container may also include a smaller, rigid cup for holding the fluid once dispensed from the container.

The container may be shaped to allow for easy and efficient stacking and storage for transport. In this manner, the container reduces warehousing demands and makes a more efficient use of limited shelf space. In use, a user may remove a perforated portion to create an aperture in the container such that the nozzle is exposed and rests inside the aperture. The user may also remove the cup from inside the enclosure. The user activates the nozzle such that the laundry detergent is dispensed.

A laundry detergent container of the present invention has the advantage of using a higher percentage of environmentally friendly materials. For example, while typical liquid detergent containers are constructed entirely of plastic, laundry detergent containers of the present invention are constructed of materials such as corrugated cardboard with a smaller quantity of plastic used for an internal bladder. Additionally, a container of embodiments of the present invention may be configured to fold flat or otherwise collapse after use (once emptied) for more efficient recycling and/or disposal.

### BRIEF DESCRIPTION OF THE DRAWINGS

For a fuller understanding of the nature and objects of the invention, reference should be made to the following detailed description taken in conjunction with the accompanying drawings, in which:

FIG. 1. is a perspective view of a laundry detergent container according to an embodiment of the present invention; and

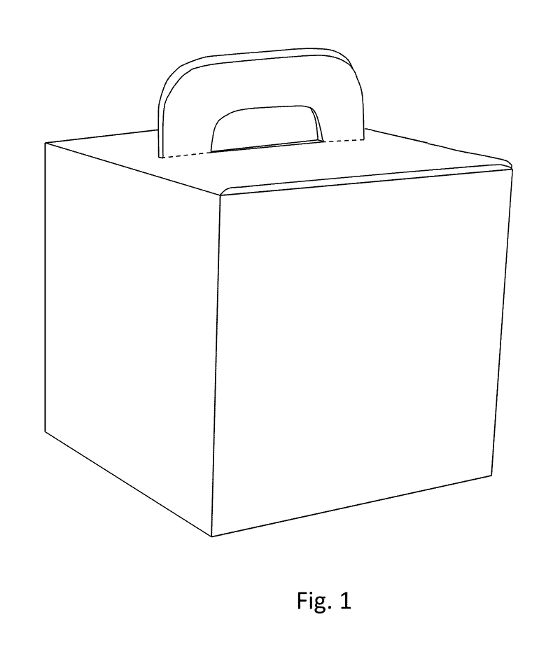

FIG. 2. is another perspective view of the laundry detergent container of FIG. 1 shown with the dispensing nozzle protruding through an aperture and showing the dispensing cup.

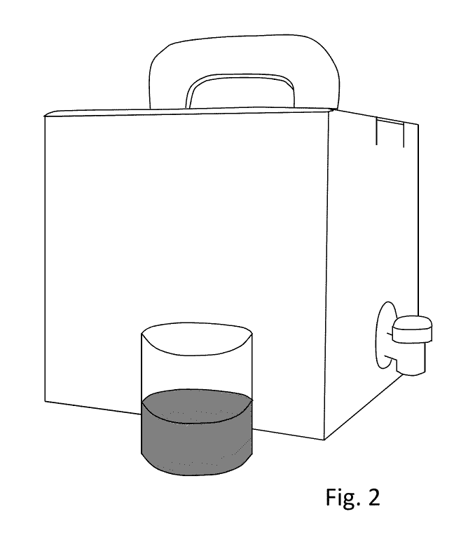

### DETAILED DESCRIPTION OF THE INVENTION

A fluid containment and delivery device according to one embodiment of the present invention comprises an enclosure, a flexible bladder housed in the enclosure, and a dispensing nozzle attached to the flexible bladder. The device may further comprise a dispensing cup to facilitate holding the dispensed fluid. The enclosure may be shaped as substantially a parallelepiped—for example, without limitation, a cube.

The enclosure is constructed from a generally rigid material such as corrugated cardboard. The enclosure may be formed in such a manner that a flat material is folded to form a parallelepiped shape. Once the flat material is folded (similar to folding a cardboard box), the end portions may be fixed with an adhesive. Such construction also enables the laundry detergent container of embodiments of the present invention to be folded flat after emptying for convenient disposal and/or recycling.

In an embodiment, the enclosure may have a foldable handle such that it can be used to carry the entire container. When not in use, the handle may be folded flat with the enclosure such that other objects, including other containers, may be stacked on the top surface. Laundry detergent containers are moved quite often and require a robust handle that can withstand frequent use to carry the container.

Laundry detergent containers are typically used in wet environments by user who may have wet hands. Therefore, the enclosure may also be covered in a thin material that is resistant to moisture. For example, the material used to construct the enclosure may be laminated with a polymer layer.

In an embodiment, the enclosure is a cube which measures 6½″×6½″×6½″ and is capable of containing a bladder which holds a gallon of laundry detergent. Such a cube shape offers the benefit of a broad base for easy stacking and no tipping of the device on a flat surface. The enclosure may also include a surface having a perforated portion such that an aperture may be formed by applying pressure to the surface of the perforated portion. The nozzle of the bladder is pulled through the aperture such that the liquid may be dispensed without disassembling the enclosure. The enclosure may also have a slanted bottom surface such that the bladder is supported above the nozzle to allow gravity to better feed the laundry detergent to the nozzle. The viscosity of laundry detergent may be lowered, in order to allow the fluid to more readily flow form the container and to allow the bladder to more completely empty.

The bladder may be constructed from a flexible material, such as a polymer. In this way, the bladder can collapse as fluid is dispensed making it unnecessary for air to enter the container and compensate for removed fluid. During production, fluid is dispensed into the bladder through an opening. Once filled, a dispensing nozzle is affixed to the opening of the bladder such that the dispensing nozzle allows the contained fluid to be selectively dispensed. The dispensing nozzle may be welded to the bladder at the opening to create a fluid-tight connection.

The nozzle is designed to dispense a viscous liquid and may be pulled through an aperture in the container in order to be accessible to the user. The nozzle is actuated through a lever, a button, or other method commonly known in the art. The nozzle may allow the user to control the rate of fluid dispensing. In other embodiments, the nozzle may only allow the user to start and stop the flow of fluid.

The dispensing cup is constructed of a material capable of holding the fluid. In one embodiment the dispensing cup may be shaped substantially as a cylinder. In another embodiment, the dispensing cup may have a spout to assist the user in pouring the laundry detergent. The dispensing cup may have graduated marks denoting various volumes of the dispensing cup.

The dispensing cup may be designed to attach to the nozzle in such a manner that the nozzle's actuation means is protected from accidental actuation. In an embodiment the receptacle is fitted to snap onto the nozzle after it is pulled through the aperture in the enclosure.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A laundry detergent container, comprising:
an enclosure;
a flexible bladder disposed within the enclosure for containing the laundry detergent;
a dispensing nozzle in communication with the bladder capable of selectively regulating the flow of the laundry detergent; and
a dispensing cup placed inside the enclosure capable of removal from the enclosure to facilitate holding the dispensed laundry detergent.

2. The device of claim 1, wherein the enclosure constructed from corrugated cardboard.

3. The device of claim 1, wherein the dispensing cup is capable of attachment to the nozzle.

4. The device of claim 1, wherein the enclosure has a handle.

5. The device of claim 1, wherein the enclosure has a removable perforated portion.

6. The device of claim 1, wherein the dispensing cup has markings to indicate the volume of the dispensing cup when filled to each marking.

7. The device of claim 1, further comprising a slanted surface inside the enclosure such that the bladder is supported above the nozzle.

8. A method for filling a laundry detergent container, comprising the steps of:
(a) providing an enclosure which is open on one end and having foldable flaps for closing the open end;
(b) placing a flexible bladder within the enclosure, the bladder having an opening;
(c) filling the flexible bladder with liquid laundry detergent through the opening;
(d) affixing a dispensing nozzle to the flexible bladder at the opening such that the bladder and dispensing nozzle completely contain the laundry detergent; and
(e) closing the substantially cubic enclosure.
